(19) United States
(12) Patent Application Publication
(10) Pub. No.: US 2026/0320477 A1
(43) Pub. Date: Oct. 15, 2026

(54) Leveraging Data Backups for Sustainable Artificial Intelligence Model Training

(71) Applicant: Dell Products L.P., Round Rock, TX (US)

(72) Inventors: Ophir Buchman, Raanana (IL); Yevgeni Gehtman, Modi'in (IL); Yuval Harduf, Yahud (IL)

(21) Appl. No.: 19/175,903

(22) Filed: Apr. 10, 2025

(51) Int. Cl. G06F 16/11; G06F 11/30; G06F 16/182; G06N 20/00

(52) U.S. Cl. CPC G06N 20/00; G06F 11/3062; G06F 16/128; G06F 16/182

(57) ABSTRACT

A system can back up data from a first data center to a second data center, to produce backed up data. The system can train the artificial intelligence model at the first data center, wherein the artificial intelligence model is trained on the data. The system can create a checkpoint of the training. The system can, based on determining that a second energy cost at the second data center will be lower than a first energy cost at the first data center at a future time, transfer the checkpoint to the second data center. The system can continue to train the artificial intelligence model at the second data center based on the checkpoint, wherein the continuing to train the artificial intelligence model uses the backed up data. The system can determine inference data representative of an inference using the trained artificial intelligence model.

### BACKGROUND

Artificial intelligence (AI) models can be trained to perform particular tasks (sometimes referred to as performing an inference). Training a model can comprise passing a dataset through the model multiple times, where one of these times can be referred to as an epoch.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can back up data from a first data center to a second data center, to produce backed up data, wherein the backing up is performed independently of training an artificial intelligence model. The system can train the artificial intelligence model at the first data center, wherein the artificial intelligence model is trained on the data, and wherein the training comprises epochs. The system can create a checkpoint of the training, wherein the checkpoint comprises parameters of the artificial intelligence model. The system can, based on determining that a second energy cost at the second data center will be lower than a first energy cost at the first data center at a future time, transfer the checkpoint to the second data center. The system can continue to train the artificial intelligence model at the second data center based on the checkpoint, wherein the continuing to train the artificial intelligence model uses the backed up data, to produce a trained artificial intelligence model. The system can, based on a request for an inference relating to the data, determine inference data representative of the inference using the trained artificial intelligence model.

An example method can comprise training, by a system comprising at least one processor, an artificial intelligence model at a first data center, wherein the artificial intelligence model is trained on data. The method can further comprise creating, by the system, a checkpoint of the training, wherein the checkpoint comprises parameters of the artificial intelligence model. The method can further comprise based on determining that a second energy cost at the second data center is threshold likely to be lower than a first energy cost at the first data center, transferring, by the system, the checkpoint to a second data center. The method can further comprise continuing, by the system, to train the artificial intelligence model at the second data center based on the checkpoint, wherein the continuing to train the artificial intelligence model uses a backup of the data of the first data center that is stored at the second data center, to produce a trained artificial intelligence model. The method can further comprise performing, by the system, an inference using the trained artificial intelligence model.

An example non-transitory computer-readable medium can comprise instructions that, in response to execution, cause a system comprising a processor to perform operations. These operations can comprise training an artificial intelligence model via a first data center, wherein the artificial intelligence model is trained on data of the first data center. These operations can further comprise creating a checkpoint corresponding to the training, wherein the checkpoint comprises parameters of the artificial intelligence model. These operations can further comprise transferring the checkpoint to a second data center. These operations can further comprise continuing to train the artificial intelligence model via the second data center based on the checkpoint, and wherein the continuing to train the artificial intelligence model uses a backup of the data of the first data center that is stored at the second data center, to produce a trained artificial intelligence model.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate leveraging data backups for sustainable AI model training, in accordance with an embodiment of this disclosure;

FIG. 2 illustrates an example of varying energy costs, and that can facilitate leveraging data backups for sustainable AI model training, in accordance with an embodiment of this disclosure;

FIG. 3 illustrates an example of single-site training costs, and that can facilitate leveraging data backups for sustainable AI model training, in accordance with an embodiment of this disclosure;

FIG. 4 illustrates an example of multiple-site training costs, and that can facilitate leveraging data backups for sustainable AI model training, in accordance with an embodiment of this disclosure;

FIG. 5 illustrates another example process flow that can facilitate leveraging data backups for sustainable AI model training, in accordance with an embodiment of this disclosure;

FIG. 6 illustrates another example process flow that can facilitate leveraging data backups for sustainable AI model training, in accordance with an embodiment of this disclosure;

FIG. 7 illustrates another example process flow that can facilitate leveraging data backups for sustainable AI model training, in accordance with an embodiment of this disclosure;

FIG. 8 illustrates another example process flow that can facilitate leveraging data backups for sustainable AI model training, in accordance with an embodiment of this disclosure;

FIG. 9 illustrates another example process flow that can facilitate leveraging data backups for sustainable AI model training, in accordance with an embodiment of this disclosure;

FIG. 10 illustrates another example process flow that can facilitate leveraging data backups for sustainable AI model training, in accordance with an embodiment of this disclosure;

FIG. 11 illustrates another example process flow that can facilitate leveraging data backups for sustainable AI model training, in accordance with an embodiment of this disclosure; and

FIG. 12 illustrates an example block diagram of a computer operable to execute an embodiment of this disclosure.

### DETAILED DESCRIPTION

### Overview

The present techniques can facilitate optimizing (or improving; where a superlative is used herein, it can be appreciated that there can be examples that show satisfactory, but not optimal, results) the costs of training large-scale deep learning models by leveraging data backups and “checkpointing” to transition training operations dynamically across different geographic regions.

Where energy costs fluctuate throughout a period of time (e.g., they are lower at night than during the day), the present techniques can take advantage of lower nighttime energy costs by initiating training during off-peak hours in one region, saving the training state as a checkpoint, and then transferring this checkpoint to another region where nighttime has just started.

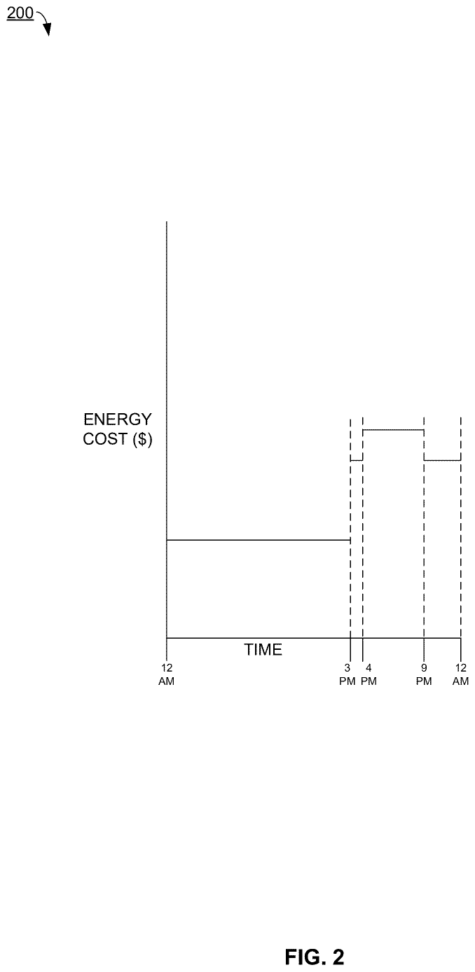

By continuously rotating training operations through multiple regions, the present techniques can minimize (or reduce) the reliance on costly peak-hour energy, significantly reducing overall training expenses. An example of varying energy costs is shown in FIG. 2.

Deep learning, particularly the training of large-scale models, can require substantial computational resources and energy consumption. For instance, training a single 200-billion-parameter Large Language Model (LLM) on example cloud computing instances can consume approximately 11.9 gigawatt-hours (GWh) of energy, which can be enough energy to power more than one thousand average American households for an entire year. This enormous energy demand can translate into high operational costs for organizations, which can make developing and deploying state-of-the-art artificial intelligence (AI) models financially burdensome.

Consider an example where a deep learning model requires 24 hours of continuous training. Given that energy prices can vary based on time of day and region, training such a model during peak hours can lead to high costs. Energy can typically be cheaper at night, but prior approaches to training frameworks do not take advantage of this fluctuation, resulting in missed opportunities for cost savings. Furthermore, a need for uninterrupted, high-power computing resources can accentuate the financial impact on organizations striving to remain competitive in AI.

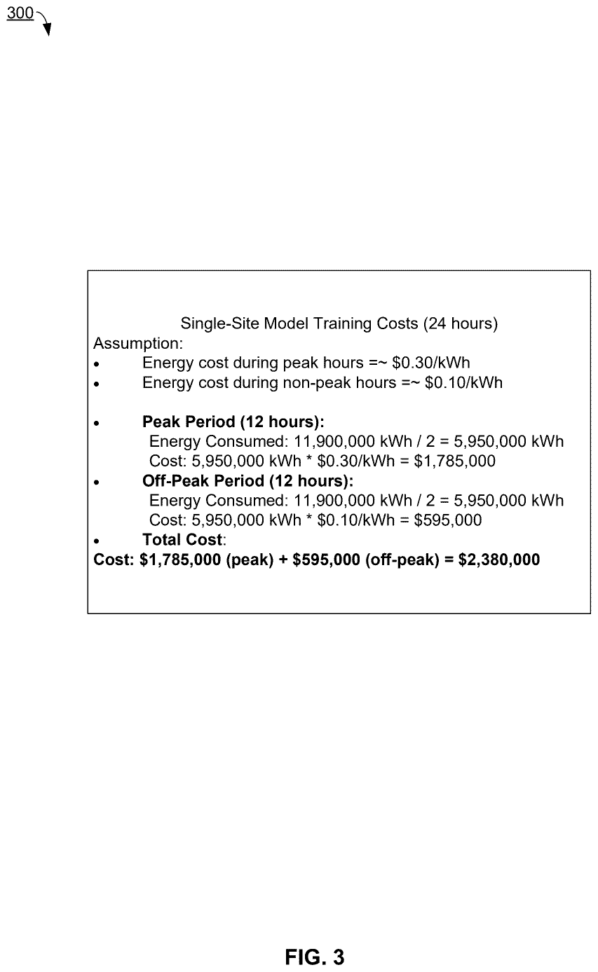

An example of single site training costs is shown in FIG. 3.

There can be challenges associated with optimizing these training costs while ensuring that the training process remains efficient and robust. Leveraging existing data backups across different regions, transitioning training operations to times and places where energy is more affordable, and effectively utilizing lower nighttime energy prices can be effectuated through the present techniques. Addressing this problem can facilitate making deep learning more sustainable and accessible, allowing organizations to innovate without being constrained by prohibitive energy costs.

The present techniques can aim to significantly reduce the high costs of training large-scale deep learning models by leveraging data backups and checkpointing to transition training operations between different regions. This approach can capitalize on lower energy costs during nighttime in different regions, allowing continuous, sustainable, cost-effective training.

Organizations can maintain data backups across multiple regions for redundancy. By having the same data accessible from numerous geographic locations, backups can be repurposed and leveraged to facilitate distributed training.

The present techniques can leverage these backups to seamlessly transfer training operations between regions.

A seamless migration of the training operations is performed by leveraging “training checkpoints” to halt and transfer a training process between different sites. In some examples, this can be effectuated with site-local distributed machine learning (ML) and high-performance computing (HPC) to ensure the continuity and resilience of training processes in cases of graphics processing unit (GPU) failure.

An example process according to the present techniques can include the following steps.

Creating Checkpoints: This can involve saving a model's state at specific intervals during the training process. This can include the model's weights, gradients, optimizer states, and other relevant training parameters. By saving these states, training can be paused and resumed without losing progress.

Checkpoints can be defined at every fixed interval or the end of each training epoch. They can be stored in a secure, accessible location, such as cloud storage, which can be accessed from multiple regions.

Halting and Transferring Training: At the end of the “off-peak” period in the local region, the training process can be paused, and the latest checkpoint can be transferred to the next region (where off-peak hours are beginning).

Resuming Training: The backup data can be mounted in the new region, and the transferred checkpoint can be loaded to resume training from the exact progress (point-in-time) where it was paused. Training continues in this region throughout the off-peak hours.

This process can be repeated as needed, transitioning between regions to leverage continuous off-peak energy costs.

Completing Training: Once the training is complete, the final model state can be saved as a checkpoint, and the model can be deployed for production use.

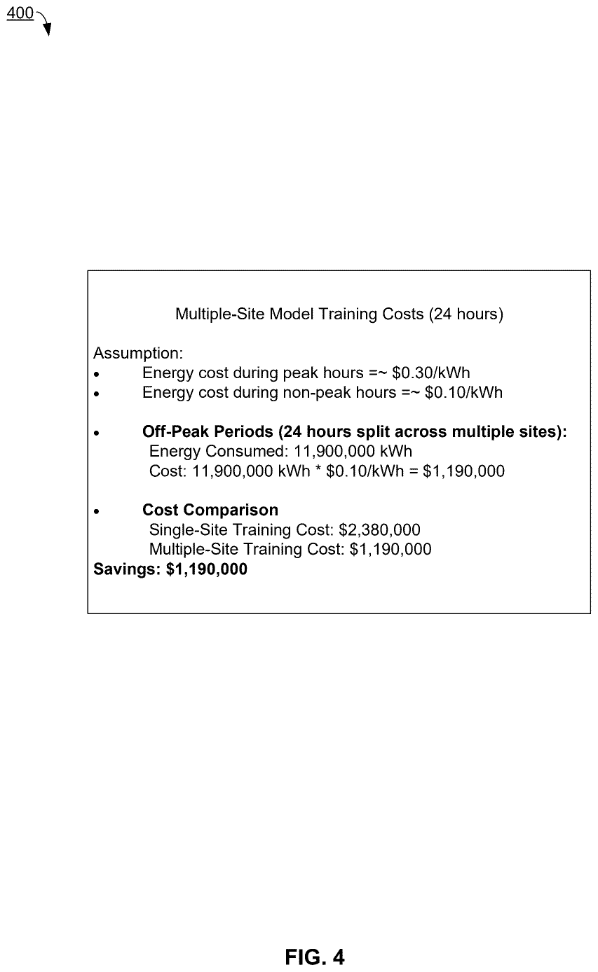

An example of single site training costs is shown in FIG. 4.

The present techniques can leverage data backups for optimal AI model training costs by transitioning the training operations between regions.

The present techniques can be implemented for the following benefits. A benefit can be cost reduction. Cheaper nighttime energy rates can significantly lower the overall training costs. The model can take advantage of lower energy prices by continuously moving the training process to regions where nighttime has just begun.

Another benefit can be efficiency. The continuous training cycle, utilizing different regions based on time zones, can ensure that training resources are used efficiently without idle periods (at night).

Another benefit can be resilience and redundancy. The present techniques can benefit from increased resilience by having training capabilities in both the production and backup sites. Training can continue at another site without significant disruption if there is any unforeseen outage at one site.

Another benefit can relate to scalability. The present techniques can be inherently scalable, as additional regions and backups can be integrated into the training cycle to optimize costs and resources further.

There can be scenarios where there will not always be a perfect overlap in off-peak time frames across different regions. In such cases, the present techniques can maximize the utilization of available off-peak windows, even if they do not align perfectly. By doing this, cost savings can be achieved compared to running everything exclusively in a single region.

An example of handling non-overlapping off-peak windows is as follows:
1. Flexible Scheduling and Checkpoints: Training operations can be synchronized with available off-peak hours in different regions, leveraging checkpoints to pause and resume training as needed. This can ensure the continuation of training with minimal interruptions.
2. Dynamic Reallocation: Use a dynamic reallocation strategy to identify the next best region with off-peak times closest to the training state checkpoint, thereby reducing waiting times and maintaining momentum.
3. Incremental Savings: Even if off-peak windows are not fully aligned, the incremental savings from running partial segments of the training during off-peak hours across multiple regions can still significantly reduce overall energy costs compared to a single-region approach.

The present techniques can leverage existing infrastructure and data backups to optimize AI training costs without requiring extensive new setups, as follows:
1. Leveraging Existing Infrastructure: The present techniques can utilize existing data backups and already established data centers in different regions. Many organizations can have geographically distributed data backup sites for redundancy and disaster recovery purposes. The present techniques can use these existing resources to transition AI training operations based on energy cost-efficiency.
2. Optimizing Energy Costs: Operational costs can be reduced by transitioning training to regions where energy is more affordable and utilizing lower nighttime energy prices. This can present an impactful way to make deep learning more cost-effective and sustainable.
3. Maintenance and Skilled Personnel: The present techniques can integrate into existing structures of distributed teams managing global network infrastructure, potentially without a significant increase in operational overhead.
4. Cost Reduction through Transitioning: Savings can be obtained by optimizing the timing and location of training operations. This added layer of efficiency can provide incremental can comprise 175 billion parameters. The size of an example checkpoint in inference format saved with float16 data type is 13 gigabytes (GB):

$$\frac{7 * 1 {0}^{9} parameters * 2 bytes per parameter}{102 {4}^{3} bytes per gigabyte} = 13 gigabytes$$

This size can be negligible compared to the size of a corresponding data set.

This present techniques can facilitate cost reductions that users can experience with on-prem (on premises) hardware, such as in a scenario of edge orchestrator as a service (EOaaS), which can support provisioning datacenter blueprints in on-prem environments and can also support planning backups, load balancing, and distributing AI workloads, etc.

### Example Architectures

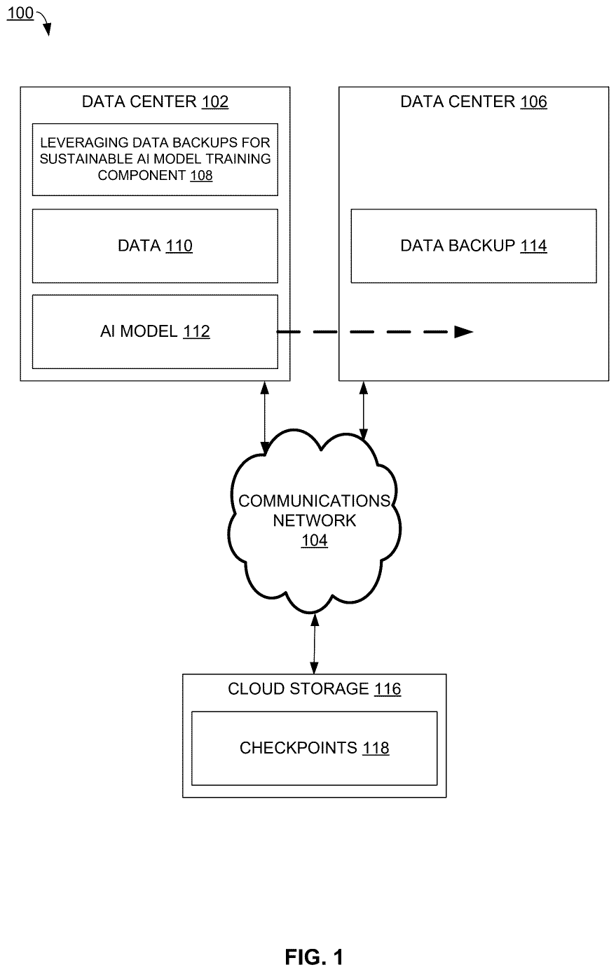

FIG. 1 illustrates an example system architecture 100 that can facilitate leveraging data backups for sustainable AI model training, in accordance with an embodiment of this disclosure.

System architecture 100 comprises data center 102, communications network 104, data center 106, and cloud storage 116. In turn, data center 102 comprises leveraging data backups for sustainable AI model training component 108, data 110, and AI model 112. Data center 106 comprises data backup 114, and cloud storage 116 comprises checkpoints 118.

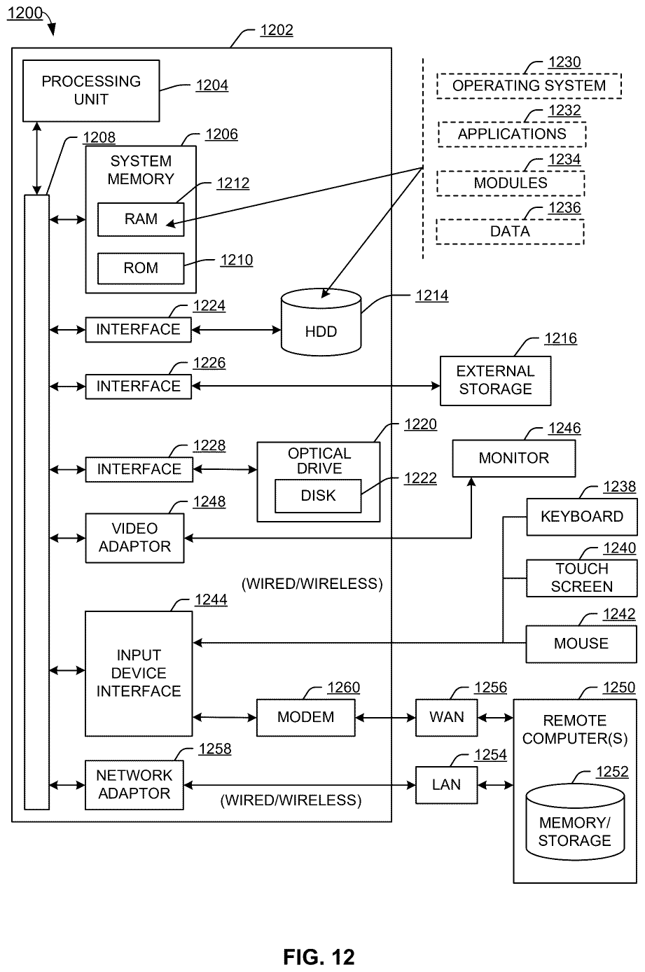

Each of data center 102, data center 106, and/or cloud storage 116 can be implemented with part(s) of computing environment 1200 of FIG. 12. Communications network 104 can comprise a computer communications network, such as the Internet.

Data center 102 can begin training AI model 112 on data 110. At certain points, checkpoints of this training can be made (e.g., at the end of a training epoch, where a checkpoint comprises model parameters for the model). Where leveraging data backups for sustainable AI model training component 108 determines that further training of AI model 112 can be undertaken more cheaply (in terms of energy costs) at data center 106, training at data center 102 can pause, the checkpoint can be made available to data center 106 (e.g., data center 102 uploads the checkpoint to cloud storage 116, where it is stored as part of checkpoints 118, and from there, downloaded by data center 106), and data center 106 can resume training the AI model.

Where data center 102 and data center 106 store backups of the respective data center's data (shown here as data 110 and data backup 114) independently of model training, then the training data of that data that is used to train the model can already be available at data center 106, and time and computing resources spent transferring the data just for model training can be avoided.

In this manner, AI model training can be spread over multiple data centers in a way that can reduce associated energy costs compared to training the AI model at a single data center.

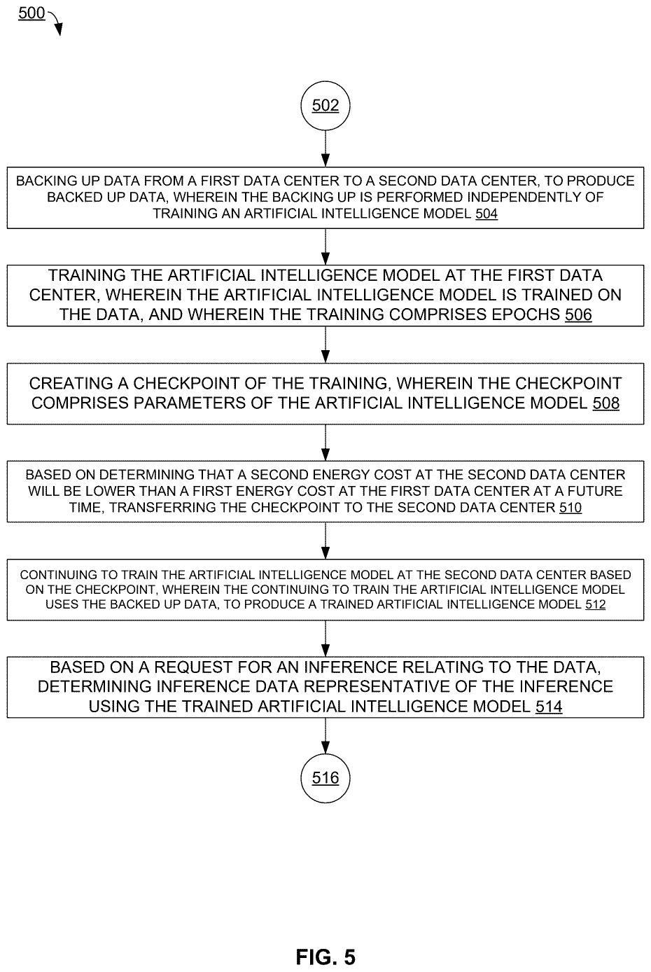

In some examples, leveraging data backups for sustainable AI model training component 108 can implement part(s) of the process flows of FIGS. 5-11 to implement leveraging data backups for sustainable AI model training.

It can be appreciated that system architecture 100 is one example system architecture for leveraging data backups for sustainable AI model training, and that there can be other system architectures that facilitate leveraging data backups for sustainable AI model training.

FIG. 2 illustrates an example 200 of varying energy costs, and that can facilitate leveraging data backups for sustainable AI model training, in accordance with an embodiment of this disclosure. In some examples, part(s) of example 200 can be used by system architecture 100 of FIG. 1 to facilitate promotion of deduplication keys in cache on read.

As illustrated in example 200, energy costs at a data center can vary over time (such as over the course of a day). According to the present techniques, different energy costs of different data centers at a given point in time can be leveraged to migrate training of an AI model across multiple data centers to minimize (or satisfactorily improve) energy costs associated with the training.

FIG. 3 illustrates an example 300 of single-site training costs, and that can facilitate leveraging data backups for sustainable AI model training, in accordance with an embodiment of this disclosure. In some examples, part(s) of example 300 can be used by system architecture 100 of FIG. 1 to facilitate promotion of deduplication keys in cache on read.

In example 300, an AI model is trained at one data center, and associated energy costs with training are shown. This can be viewed in contrast to example 400 of FIG. 4, where an AI model is trained across multiple data centers, and the energy costs are lower relative to example 300.

FIG. 4 illustrates an example 400 of multiple-site training costs, and that can facilitate leveraging data backups for sustainable AI model training, in accordance with an embodiment of this disclosure. In some examples, part(s) of example 400 can be used by system architecture 100 of FIG. 1 to facilitate promotion of deduplication keys in cache on read.

In example 400, an AI model is trained at multiple data center, and associated energy costs with training are shown. This can be viewed in contrast to example 300 of FIG. 3, where an AI model is trained at one data center, and the energy costs are higher relative to example 400.

### Example Process Flows

FIG. 5 illustrates an example process flow 500 that can facilitate leveraging data backups for sustainable AI model training, in accordance with an embodiment of this disclosure. In some examples, one or more embodiments of process flow 500 can be implemented by leveraging data backups for sustainable AI model training component 108 of FIG. 1, or computing environment 1200 of FIG. 12.

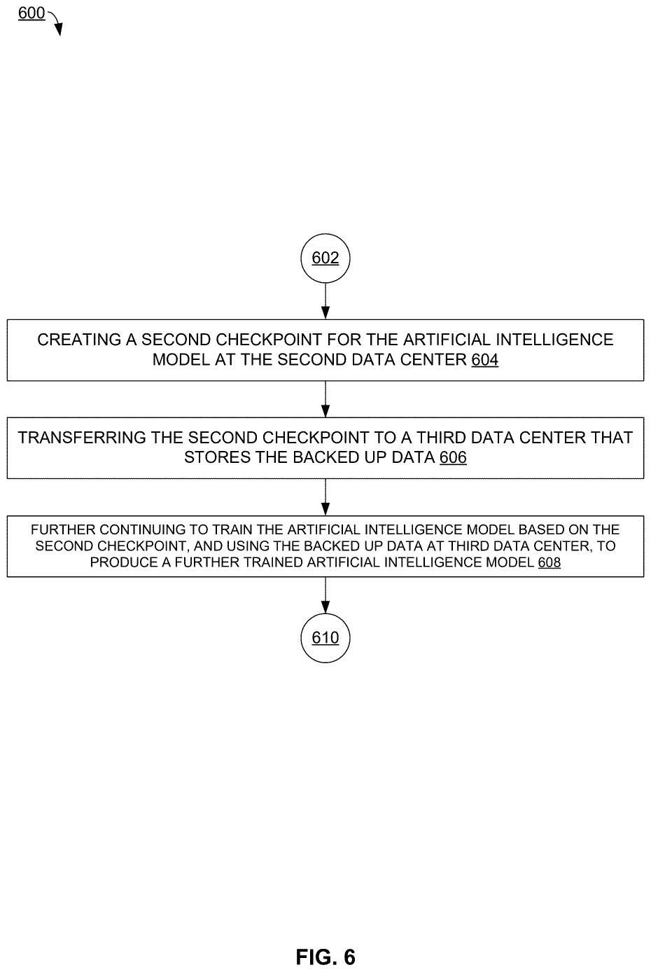

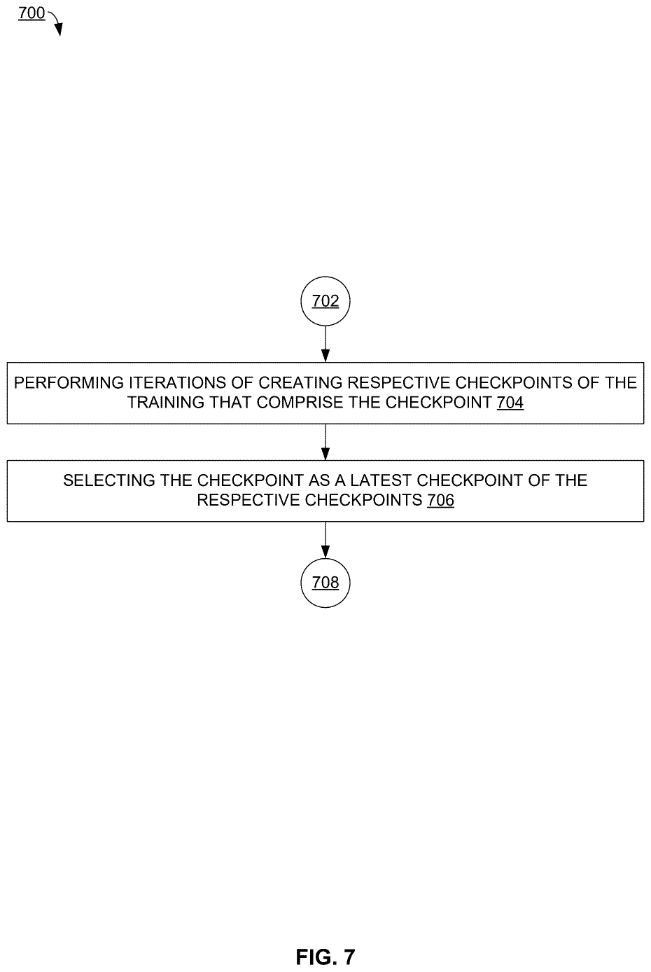

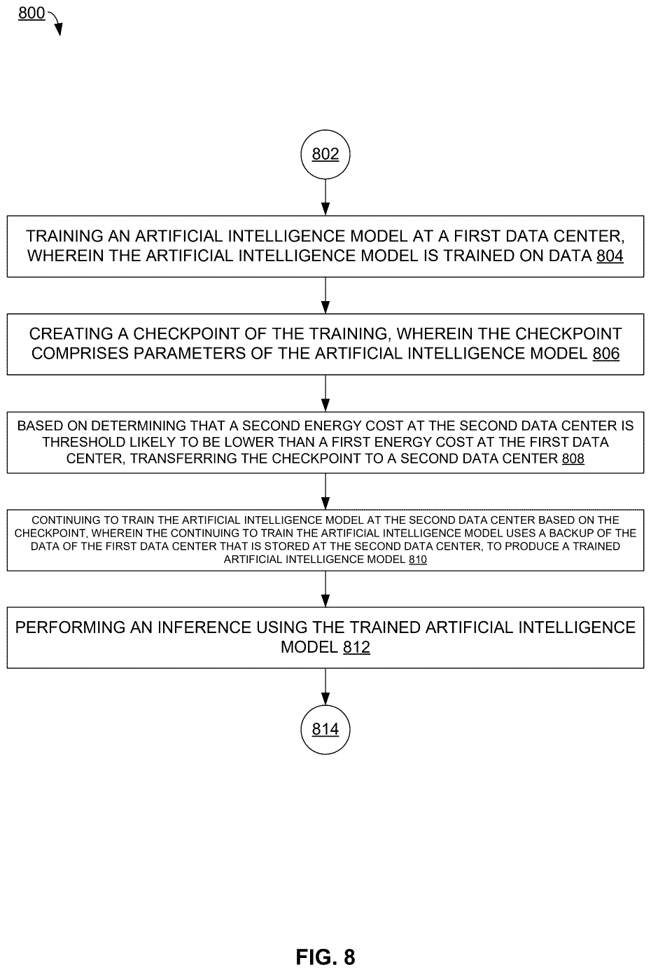

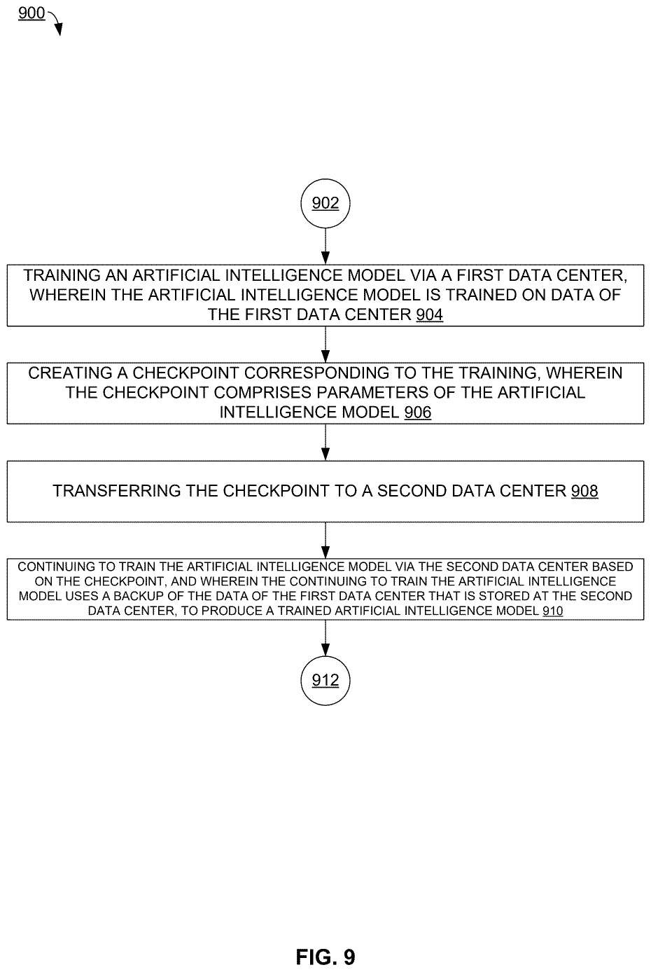

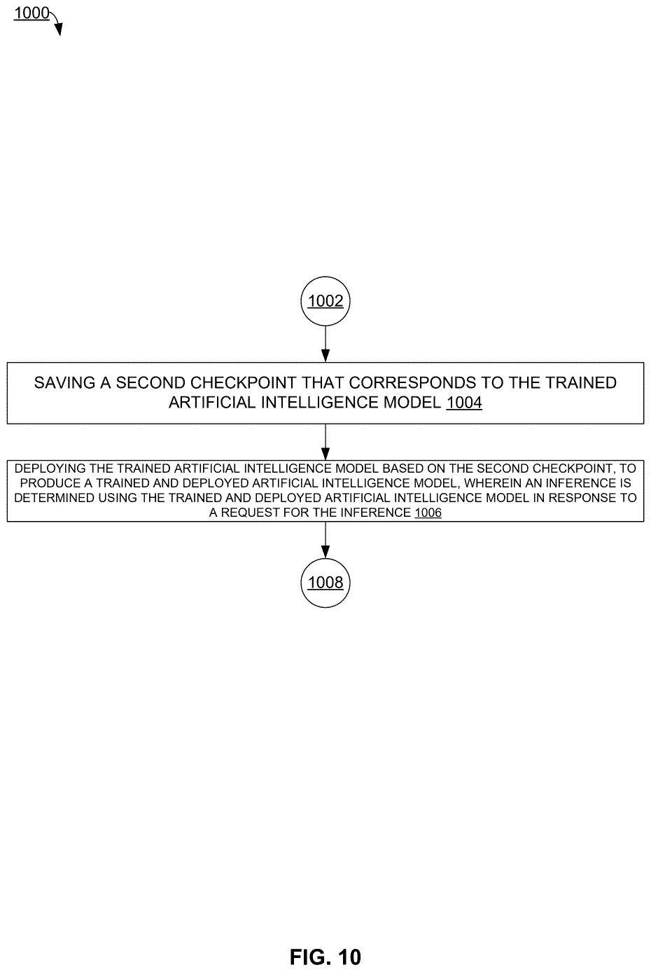

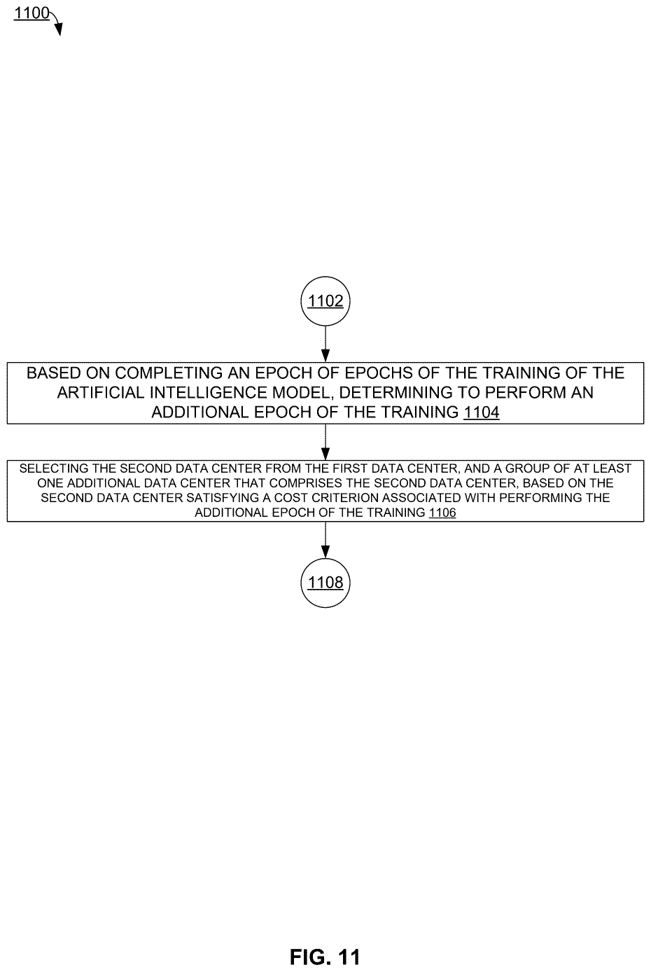

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, and/or process flow 1100 of FIG. 11.

Process flow 500 begins with 502, and moves to operation 504.

Operation 504 depicts backing up data from a first data center to a second data center, to produce backed up data, wherein the backing up is performed independently of training an artificial intelligence model. Using the example of FIG. 1, data center 102 can store data 110, and a backup of that data can be made and stored as data backup 114 of data center 106. Similarly, data at data center 106 can be backed up at data center 102. Put another way, with respect to training data used to train AI model 112, it can be that a copy of that training data is stored at each data center based on performing backups according to a schedule (compared to transferring it to another data center for the express purpose of model training).

After operation 504, process flow 500 moves to operation 506.

Operation 506 depicts training the artificial intelligence model at the first data center, wherein the artificial intelligence model is trained on the data, and wherein the training comprises epochs. Continuing with the example of FIG. 1, this can comprise AI model 112 being trained at data center 102, and on data 110 as training data. An epoch can comprise one pass through the training data to train the model.

After operation 506, process flow 500 moves to operation 508.

Operation 508 depicts creating a checkpoint of the training, wherein the checkpoint comprises parameters of the artificial intelligence model. This can be a checkpoint of checkpoints 118, and generated at data center 102, then transferred from data center 102 to cloud storage 116. The checkpoint can be accessible to both data center 102 and data center 106 from cloud storage 116.

After operation 508, process flow 500 moves to operation 510.

Operation 510 depicts based on determining that a second energy cost at the second data center will be lower than a first energy cost at the first data center at a future time, transferring the checkpoint to the second data center. Continuing with the example of FIG. 1, leveraging data backups for sustainable AI model training component 108 can maintain information on different energy costs at different data centers at different times (which can be similar to example 200 of FIG. 2), and from this determine that data center 106 will be cheaper the data center 102 for further training of the model (e.g., for performing at least one more training epoch).

In some examples, operation 510 comprises pausing the training of the artificial intelligence model at the first data center before the transferring of the checkpoint to the second data center. That is, training can be paused at the first data center, and then resumed at the second data center. In some examples, the pausing and the transferring can be performed together, where training is paused and a checkpoint is transferred (or some amount of training continues after transferring the checkpoint; e.g., where there is an attempt to train another epoch at the data center, but the data center experiences a problem, so training is resumed at another data center as of a most recent checkpoint).

In some examples, operation 508 comprises performing respective iterations of creating respective checkpoints of the training that comprise the checkpoint. In some examples, the respective iterations are performed at a fixed time interval. In some examples, the respective iterations are performed based on completing respective training epochs of the epochs. That is, multiple checkpoints can be created over time. For example, checkpoints can be defined at each fixed interval or the end of each training epoch. They can be stored in a secure, accessible location, such as cloud storage, which can be accessed from multiple regions.

In some examples, operation 508 comprises performing iterations of creating respective checkpoints of the training that comprise the checkpoint, and wherein the checkpoint is a latest checkpoint of the respective checkpoints. That is, checkpoints can be made over time, and when model training is transferred to another data center, the latest checkpoint can be used at that data center to resume training, with the other checkpoints discarded.

After operation 510, process flow 500 moves to operation 512.

Operation 512 depicts continuing to train the artificial intelligence model at the second data center based on the checkpoint, wherein the continuing to train the artificial intelligence model uses the backed up data, to produce a trained artificial intelligence model. That is, data center 102 can indicate to data center 106 to continue training the model. Data center 106 can download the checkpoint from cloud storage 116 (or otherwise obtain it, such as by data center 102 sending it to data center 106). Data center 106 can update its copy of the model to incorporate the parameters of the checkpoint, and then further train the checkpoint.

After operation 512, process flow 500 moves to operation 514.

Operation 514 depicts based on a request for an inference relating to the data, determining inference data representative of the inference using the trained artificial intelligence model. That is, once the AI model training has been completed, the trained AI model can be used for performing inference.

After operation 514, process flow 500 moves to 516, where process flow 500 ends.

FIG. 6 illustrates an example process flow 600 that can facilitate leveraging data backups for sustainable AI model training, in accordance with an embodiment of this disclosure. In some examples, one or more embodiments of process flow 600 can be implemented by leveraging data backups for sustainable AI model training component 108 of FIG. 1, or computing environment 1200 of FIG. 12.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 500 of FIG. 5, process flow 700 of FIG. 7, process flow 800 of FIG. 8, process flow 900 of FIG. 9, process flow 1000 of FIG. 10, and/or process flow 1100 of FIG. 11.

In some examples, process flow 600 is implemented in conjunction with process flow 500 of FIG. 5, and the checkpoint is a first checkpoint. In some examples, process flow 600 can be used to implement operation 512.

Process flow 600 begins with 602, and moves to operation 604.

Operation 604 depicts creating a second checkpoint for the artificial intelligence model at the second data center. That is, in continuing to train the model at the second data center (e.g., data center 106 of FIG. 1), a checkpoint of the training can be made, such as at the completion of a training epoch.

After operation 604, process flow 600 moves to operation 606.

Operation 606 depicts transferring the second checkpoint to a third data center that stores the backed up data. Using the example of FIG. 1, this can be similar to data center 102 transferring a checkpoint to data center 106, as applied to data center 106 transferring another checkpoint to another data center (or back to data center 102) for further training.

After operation 606, process flow 600 moves to operation 608.

Operation 608 depicts further continuing to train the artificial intelligence model based on the second checkpoint, and using the backed up data at third data center, to produce a further trained artificial intelligence model. That is, once the checkpoint has been transferred to another data center, training of the model can continue at this data center. In this manner, training of an AI model can occur across an arbitrary number of data centers (where some data centers can perform training on the model multiple different times).

After operation 608, process flow 600 moves to 610, where process flow 600 ends.

FIG. 7 illustrates an example process flow 700 that can facilitate leveraging data backups for sustainable AI model training, in accordance with an embodiment of this disclosure. In some examples, one or more embodiments of process flow 700 can be implemented by leveraging data backups for sustainable AI model training component 108 of FIG. 1, or computing environment 1200 of FIG. 12.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 500 of FIG. 5, process flow 600 of FIG. 6, process flow 800 of FIG. 8, process flow 900 of FIG. 9, process flow 1000 of FIG. 10, and/or process flow 1100 of FIG. 11.

Process flow 700 begins with 702, and moves to operation 704.

Operation 704 depicts performing iterations of creating respective checkpoints of the training that comprise the checkpoint. That is, checkpoints can be taken over time.

After operation 704, process flow 700 moves to operation 706.

Operation 706 depicts selecting the checkpoint as a latest checkpoint of the respective checkpoints. That is, when model training is transferred to another data center, the latest checkpoint can be used at that data center to resume training, with the other checkpoints discarded of the checkpoints of operation 704 can be used.

After operation 706, process flow 700 moves to 708, where process flow 700 ends.

FIG. 8 illustrates an example process flow 800 that can facilitate leveraging data backups for sustainable AI model training, in accordance with an embodiment of this disclosure. In some examples, one or more embodiments of process flow 800 can be implemented by leveraging data backups for sustainable AI model training component 108 of FIG. 1, or computing environment 1200 of FIG. 12.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 500 of FIG. 5, process flow 600 of FIG. 6, process flow 700 of FIG. 7, process flow 900 of FIG. 9, process flow 1000 of FIG. 10, and/or process flow 1100 of FIG. 11.

Process flow 800 begins with 802, and moves to operation 804.

Operation 804 depicts training an artificial intelligence model at a first data center, wherein the artificial intelligence model is trained on data. In some examples, operation 804 can be implemented in a similar manner as operation 506 of FIG. 5.

After operation 804, process flow 800 moves to operation 806.

Operation 806 depicts creating a checkpoint of the training, wherein the checkpoint comprises parameters of the artificial intelligence model. In some examples, operation 806 can be implemented in a similar manner as operation 508 of FIG. 5.

In some examples, the parameters comprise weights of the artificial intelligence model, gradients of the artificial intelligence model, and optimizer states of the artificial intelligence model. That is, a checkpoint can comprise a model's weights, gradients, optimizer states, and other relevant training parameters.

After operation 806, process flow 800 moves to operation 808.

Operation 808 depicts, based on determining that a second energy cost at the second data center is threshold likely to be lower than a first energy cost at the first data center, transferring the checkpoint to a second data center. In some examples, operation 804 can be implemented in a similar manner as operation 506 of FIG. 5.

In some example, the second energy cost at the second data and the first energy cost at the first data center vary over time. In some examples, the second energy cost is greater than the first energy cost at a first time, and the second energy cost is less than the first energy cost at a second time later than the first time. That is, energy costs can vary, and at different times, one data center's energy costs can be cheaper or more expensive than at another data center.

In some examples, the first data center is located in a first geographical region, the second data center is located in a second geographic region, and the first geographical region differs from the second geographical region. In some examples, the first energy cost at the first data center is associated with a first time of day that satisfies a daytime criterion, and a third energy cost at the first data center is associated with a second time of day that satisfies a nighttime criterion. In some examples, the second energy cost satisfies an off-peak criterion, and wherein the first energy cost satisfies a peak criterion. That is, a reason that energy costs differ at different data centers at a point of time can be that they are located in different physical locations (e.g., it is nighttime at one data center with off-peak (lower) energy costs, while it is daytime at another data center with peak (higher) energy costs).

After operation 808, process flow 800 moves to operation 810.

Operation 810 depicts continuing to train the artificial intelligence model at the second data center based on the checkpoint, wherein the continuing to train the artificial intelligence model uses a backup of the data of the first data center that is stored at the second data center, to produce a trained artificial intelligence model. In some examples, operation 810 can be implemented in a similar manner as operations 504 and 512 of FIG. 5.

After operation 810, process flow 800 moves to operation 812.

Operation 812 depicts performing an inference using the trained artificial intelligence model. In some examples, operation 812 can be implemented in a similar manner as operation 514 of FIG. 5.

After operation 812, process flow 800 moves to 814, where process flow 800 ends.

FIG. 9 illustrates an example process flow 900 that can facilitate leveraging data backups for sustainable AI model training, in accordance with an embodiment of this disclosure. In some examples, one or more embodiments of process flow 900 can be implemented by leveraging data backups for sustainable AI model training component 108 of FIG. 1, or computing environment 1200 of FIG. 12.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 500 of FIG. 5, process flow 600 of FIG. 6, process flow 700 of FIG. 7, process flow 800 of FIG. 8, process flow 1000 of FIG. 10, and/or process flow 1100 of FIG. 11.

Process flow 900 begins with 902, and moves to operation 904.

Operation 904 depicts training an artificial intelligence model via a first data center, wherein the artificial intelligence model is trained on data of the first data center. In some examples, operation 904 can be implemented in a similar manner as operation 506 of FIG. 5.

After operation 904, process flow 900 moves to operation 906.

Operation 906 depicts creating a checkpoint corresponding to the training, wherein the checkpoint comprises parameters of the artificial intelligence model. In some examples, operation 906 can be implemented in a similar manner as operation 508 of FIG. 5.

In some examples, the creating of the checkpoint comprises storing the checkpoint in a location that is accessible to the first data center and to the second data center.

In some examples, the location that is accessible to the first data center and to the second data center comprises cloud storage equipment that is separate from storage of the first data center and to the second data center.

In some examples, the transferring of the checkpoint to the second data center comprises enabling the checkpoint to be available to the second data center via the cloud storage.

That is, Checkpoints can be defined at each fixed interval or the end of each training epoch. They can be stored in a secure, accessible location, such as cloud storage, which can be accessed from multiple regions.

After operation 906, process flow 900 moves to operation 908.

Operation 908 depicts transferring the checkpoint to a second data center. In some examples, operation 908 can be implemented in a similar manner as operation 510 of FIG. 5.

After operation 908, process flow 900 moves to operation 910.

Operation 910 depicts continuing to train the artificial intelligence model via the second data center based on the checkpoint, and wherein the continuing to train the artificial intelligence model uses a backup of the data of the first data center that is stored at the second data center, to produce a trained artificial intelligence model. In some examples, operation 804 can be implemented in a similar manner as operations 504 and 512 of FIG. 5.

After operation 910, process flow 900 moves to 912, where process flow 900 ends.

FIG. 10 illustrates an example process flow 1000 that can facilitate leveraging data backups for sustainable AI model training, in accordance with an embodiment of this disclosure. In some examples, one or more embodiments of process flow 1000 can be implemented by leveraging data backups for sustainable AI model training component 108 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 500 of FIG. 5, process flow 600 of FIG. 6, process flow 700 of FIG. 7, process flow 800 of FIG. 8, process flow 900 of FIG. 9, and/or process flow 1100 of FIG. 11.

Process flow 1000 begins with 1002, and moves to operation 1004.

In some examples where process flow 1000 is implemented in conjunction with process flow 900 of FIG. 9, the checkpoint is a first checkpoint.

Operation 1004 depicts saving a second checkpoint that corresponds to the trained artificial intelligence model. That is, a final model state after training (final in terms of this bout of training before deploying the trained model) can be saved as a checkpoint.

After operation 1004, process flow 1000 moves to operation 1006.

Operation 1006 depicts deploying the trained artificial intelligence model based on the second checkpoint, to produce a trained and deployed artificial intelligence model, wherein an inference is determined using the trained and deployed artificial intelligence model in response to a request for the inference. That is, the checkpoint that corresponds to the final model state can be deployed to a model for production use.

After operation 1006, process flow 1000 moves to 1008, where process flow 1000 ends.

FIG. 11 illustrates an example process flow 1100 that can facilitate leveraging data backups for sustainable AI model training, in accordance with an embodiment of this disclosure. In some examples, one or more embodiments of process flow 1100 can be implemented by leveraging data backups for sustainable AI model training component 118 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 1100 begins with 1102, and moves to operation 1104.

In some examples, process flow 1100 can be used to implement operation 908 of FIG. 9.

Operation 1104 depicts, based on completing an epoch of epochs of the training of the artificial intelligence model, determining to perform an additional epoch of the training. That is, it can be determined that training has not yet completed (e.g., because the model has not yet sufficiently converged on a loss function, because a predefined number of epochs have not yet been performed, and/or because an amount of computing resources allocated to the training has not yet been fully consumed).

After operation 1104, process flow 1100 moves to operation 1106.

Operation 1106 depicts selecting the second data center from the first data center, and a group of at least one additional data center that comprises the second data center, based on the second data center satisfying a cost criterion associated with performing the additional epoch of the training. That is, where more training is to occur, a data center where energy costs will be the cheapest for the next epoch of training will be selected.

After operation 1106, process flow 1100 moves to 1108, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of data center 102, data center 106, and/or cloud storage 116.

In some examples, computing environment 1200 can implement one or more embodiments of the process flows of FIGS. 5-11 to facilitate leveraging data backups for sustainable AI model training.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 13104 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 13104 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples, and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
backing up data from a first data center to a second data center, to produce backed up data, wherein the backing up is performed independently of training an artificial intelligence model;
training the artificial intelligence model at the first data center, wherein the artificial intelligence model is trained on the data, and wherein the training comprises epochs;
creating a checkpoint of the training, wherein the checkpoint comprises parameters of the artificial intelligence model;
based on determining that a second energy cost at the second data center will be lower than a first energy cost at the first data center at a future time, transferring the checkpoint to the second data center;
continuing to train the artificial intelligence model at the second data center based on the checkpoint, wherein the continuing to train the artificial intelligence model uses the backed up data, to produce a trained artificial intelligence model; and
based on a request for an inference relating to the data, determining inference data representative of the inference using the trained artificial intelligence model.

2. The system of claim 1, wherein the checkpoint is a first checkpoint, and wherein the continuing to train the artificial intelligence model at the second data center comprises:
creating a second checkpoint for the artificial intelligence model at the second data center;
transferring the second checkpoint to a third data center that stores the backed up data; and
further continuing to train the artificial intelligence model based on the second checkpoint, and using the backed up data at third data center, to produce a further trained artificial intelligence model.

3. The system of claim 1, wherein the operations further comprise:
pausing the training of the artificial intelligence model at the first data center before the transferring of the checkpoint to the second data center.

4. The system of claim 1, wherein the operations further comprise:
performing respective iterations of creating respective checkpoints of the training that comprise the checkpoint.

5. The system of claim 4, wherein the respective iterations are performed at a fixed time interval.

6. The system of claim 4, wherein the respective iterations are performed based on completing respective training epochs of the epochs.

7. The system of claim 1, wherein the operations further comprise:
performing iterations of creating respective checkpoints of the training that comprise the checkpoint, and wherein the checkpoint is a latest checkpoint of the respective checkpoints.

8. A method, comprising:
training, by a system comprising at least one processor, an artificial intelligence model at a first data center, wherein the artificial intelligence model is trained on data;
creating, by the system, a checkpoint of the training, wherein the checkpoint comprises parameters of the artificial intelligence model;
based on determining that a second energy cost at the second data center is threshold likely to be lower than a first energy cost at the first data center, transferring, by the system, the checkpoint to a second data center;
continuing, by the system, to train the artificial intelligence model at the second data center based on the checkpoint, wherein the continuing to train the artificial intelligence model uses a backup of the data of the first data center that is stored at the second data center, to produce a trained artificial intelligence model; and
performing, by the system, an inference using the trained artificial intelligence model.

9. The method of claim 8, wherein the second energy cost at the second data and the first energy cost at the first data center vary over time.

10. The method of claim 8, wherein the second energy cost is greater than the first energy cost at a first time, and wherein the second energy cost is less than the first energy cost at a second time later than the first time.

11. The method of claim 8, wherein the first data center is located in a first geographical region, wherein the second data center is located in a second geographic region, and wherein the first geographical region differs from the second geographical region.

12. The method of claim 8, wherein the first energy cost at the first data center is associated with a first time of day that satisfies a daytime criterion, and wherein a third energy cost at the first data center is associated with a second time of day that satisfies a nighttime criterion.

13. The method of claim 8, wherein the second energy cost satisfies an off-peak criterion, and wherein the first energy cost satisfies a peak criterion.

14. The method of claim 8, wherein the parameters comprise weights of the artificial intelligence model, gradients of the artificial intelligence model, and optimizer states of the artificial intelligence model.

15. A non-transitory computer-readable medium comprising instructions that, in response to execution, cause a system comprising at least one processor to perform operations, comprising:
training an artificial intelligence model via a first data center, wherein the artificial intelligence model is trained on data of the first data center;
creating a checkpoint corresponding to the training, wherein the checkpoint comprises parameters of the artificial intelligence model;
transferring the checkpoint to a second data center; and
continuing to train the artificial intelligence model via the second data center based on the checkpoint, and wherein the continuing to train the artificial intelligence model uses a backup of the data of the first data center that is stored at the second data center, to produce a trained artificial intelligence model.

16. The non-transitory computer-readable medium of claim 15, wherein the checkpoint is a first checkpoint, and wherein the operations further comprise:
saving a second checkpoint that corresponds to the trained artificial intelligence model; and
deploying the trained artificial intelligence model based on the second checkpoint, to produce a trained and deployed artificial intelligence model, wherein an inference is determined using the trained and deployed artificial intelligence model in response to a request for the inference.

17. The non-transitory computer-readable medium of claim 15, wherein the creating of the checkpoint comprises:
storing the checkpoint in a location that is accessible to the first data center and to the second data center.

18. The non-transitory computer-readable medium of claim 17, wherein the location that is accessible to the first data center and to the second data center comprises cloud storage equipment that is separate from storage of the first data center and to the second data center.

19. The non-transitory computer-readable medium of claim 17, wherein the transferring of the checkpoint to the second data center comprises:
enabling the checkpoint to be available to the second data center via the cloud storage.

20. The non-transitory computer-readable medium of claim 15, wherein the transferring of the checkpoint to the second data center comprises:
based on completing an epoch of epochs of the training of the artificial intelligence model, determining to perform an additional epoch of the training; and
selecting the second data center from the first data center, and a group of at least one additional data center that comprises the second data center, based on the second data center satisfying a cost criterion associated with performing the additional epoch of the training.
